(19) United States
(12) Patent Application Publication
(10) Pub. No.: US 2017/0081146 A1
(43) Pub. Date: Mar. 23, 2017

(54) Extension Cord Safety System

(71) Applicant: John Ernest Dockray, Brisbane (AU)

(72) Inventor: John Ernest Dockray, Brisbane (AU)

(21) Appl. No.: 14/859,355

(22) Filed: Sep. 21, 2015

(51) Int. Cl. B65H 75/14; H01B 9/00

(52) U.S. Cl. CPC B65H 75/14; H01B 9/00; B65H 2701/34

(57) ABSTRACT

An extension cord safety system designed to encourage or force the user to unplug or turn off a cord prior to rolling or unrolling the cord. Additionally, a safety system designed to automatically de-energise a cord whilst not in use. The safety system is specifically designed and intended to reduce the risk of electric shock. The extension cord safety system includes the permanent installation of a cable rolling device at the male end of the cord so the user must unplug the cord to commence rolling or unroll the cord prior to plugging into a power source.

### TECHNICAL FIELD

The present invention relates to extension cord safety systems. In particular, although not exclusively, the invention relates to extension cord safety systems for use during construction.

### BACKGROUND ART

Storage devices for extension cords exist that provide an easy way to wind up a cord directly into the storage device. These include rollers, cable tidies, cable holders bags and other similar devices.

FIG. 1 illustrates an extension cord roller 100, in a rolled-up stated, according to the prior art. The roller 100 includes a body 105 comprising a handle 110, and a reel 115 around which an extension cord 120 is wrapped. The extension cord 120 can be unwound from the reel 115 and wound back up again using a winder handle 125. FIG. 2 illustrates the roller 100 in an unrolled state.

In use, the user generally plugs a plug (male) end 130 of the extension cord 120 into a wall socket 135, and unwinds the extension cord from the roller 100 as the user walks to a work area 140. The user may then plug electrical devices into socket (female) ports 145 of the roller 100 and work in the work area 140.

After the user has completed work in the work area 140, the user generally unplugs any electrical devices from the roller 100, and rolls the extension cord 120 back up while walking back to the wall socket 135. During this process, the user may guide the extension cord 120 with their hand to prevent tangling of the cord 120 in the roller 100.

When back at the wall socket 135, the user then unplugs the male end 130 of the extension cord 120 from the wall socket 135, and then winds the final part of the extension cord 120 onto the roller 100.

At construction sites, electricians, carpenters, plumbers, and other tradespeople generally work alongside one another. Often a large number of people work together in a relatively small area, and as such, generally have overlapping workspaces. Furthermore, almost all tradespeople require the use of power tools on construction sites, for operating equipment such as electric saws, drills, lighting, and the like. Extension cords, such as that described above with reference to the extension cord roller 100, are thus typically used to supply power from a central circuit board to the work area.

One problem with extension cords of the prior art is that they often become damaged as trolleys are pushed or dragged over cords, or when sharp debris, such as roofing offcuts, comes in contact with the cords. Such damage may expose live wiring, without being noticed, and can thus cause electrocution, especially when the cord is wound up while it is still plugged in. This is particularly a problem on worksites where tradespeople share the same workspace.

Safety standards have been introduced to reduce risks associated with electricity on worksites. The standards generally include rules relating to where wiring may be placed and how it is to be installed. However, a problem with the safety standards of the prior art is that they generally inconvenient and thus may not be followed when a worker is busy or stressed.

As such, there is a need for an improved extension cord safety system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an extension cord safety system, which may at least partially overcome at least one of the abovementioned disadvantages or provide the consumer with a useful or commercial choice.

With the foregoing in view, the present invention in one form, resides broadly in a portable extension cord safety system including:

an electrical extension cord including a plug end; and

a holder for receiving and holding the electrical extension cord such that the plug end can extend from the holder to provide an extension to a power supply; wherein

the extension cord safety system is configured to encourage a user to unplug the extension cord from the power supply prior to storing the electrical extension cord on the holder.

Advantageously, electrical safety is improved as extension cords are generally unplugged prior to storing the electrical extension cord on the holder, and thus are not live. In particular, electrocution caused by contact with a damaged portion of the electrical extension cord may be reduced.

The electrical extension cord may include an output end. The output end may comprise a socket. Alternatively, the electrical extension may be coupled to a socket of the holder.

The holder may comprise an elongate body around which the cord is wrapped. The elongate body may have curved ends. The holder may include retaining portions adjacent to the curved ends to prevent the extension cord from sliding off the elongate body.

The holder may define an aperture, through which the plug end of the extension cord may extend. The holder may include a retaining clip adjacent to the aperture for retaining the socket end of the extension cord to the holder. The retaining clip may be used to attach the cord such that the plug end is able to extend 0.5 m to 1 m from the holder.

To effectively roll the cord generally requires some degree of manoeuvrability. By securing the cord to the holder close to the plug end, it may become impractical to roll the cord without un-plugging the cord first, thus encouraging the user to unplug the cord first. The extension cord safety system may be configured to encourage a user to unplug the extension cord from the power supply by making it ineffective, impractical or impossible for the holder to receive the cord while the cord is plugged in.

The extension cord safety system may encourage the user to unplug the cord from a power supply by making it easier for the user to roll up the cord when unplugged rather than plugged in.

The holder may include a hook, for hanging the holder.

The extension cord may include a handle adjacent to a socket end of the cord, to enable the user to pick up the end of the cord without touching the cord. The handle may be made of non-conductive material, such as rubber.

The extension cord may include a warning label, adjacent to the socket end of the cord, which instructs a user to unplug the cord prior to rolling it up.

Alternatively, the holder may comprise a reel. The holder may comprise a frame, reel, and handle for rotating the reel relative to the frame.

Rotation of the reel may be prevented while the cord is plugged in. Rotation of the roller may cause the plug end of the cord to also rotate, which will cause tangling of the cord if still plugged in. Alternatively, the roller may include an electrically actuated lock, a brake or the like, to prevent the roller from being rolled while plugged in.

In another form, the invention resides broadly in an electrical cord storage device including:

a holder for receiving and storing the electrical extension cord having a plug end, such that the plug end can extend from the holder to provide an extension to a power supply; wherein the storage device is configured to encourage a user to unplug the extension cord from the power supply prior to storing the electrical extension cord on the holder.

The electrical cord storage device may be configured to receive a standard electrical extension cord, without modification.

In another form, the invention resides in an electrical extension cord including a plug end and a socket end and an elongate cord portion extending between the plug end and the socket end; and a switch at the plug end, configured to selectively decouple couple the plug end from the cord portion of the cord when not in use.

The switch may be configured to detect if an electrical appliance is coupled to the socket end of the cord. The switch may be configured to detect a load or resistance at the socket end of the extension cord, or detect that a plug has been plugged into the socket end of the cord.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates an example extension cord roller, in a rolled-up stated, according to the prior art;

FIG. 2 illustrates the roller of FIG. 1 in an unrolled state;

FIG. 3 illustrates a front view of an electrical cord storage device, according to an embodiment of the present invention;

FIG. 4 illustrates a side view of the electrical cord storage device of FIG. 3;

FIG. 5 illustrates an extension cord on the electrical cord storage device of FIG. 3;

FIG. 6 illustrates the extension cord unwound from the electrical cord storage device of FIG. 3, plugged into an electrical socket and leading to a work area;

FIG. 7 illustrates a front view of an electrical cord storage device, according to an embodiment of the present invention; and

FIG. 8 illustrates an end of an extension cord, according to an embodiment of the present invention.

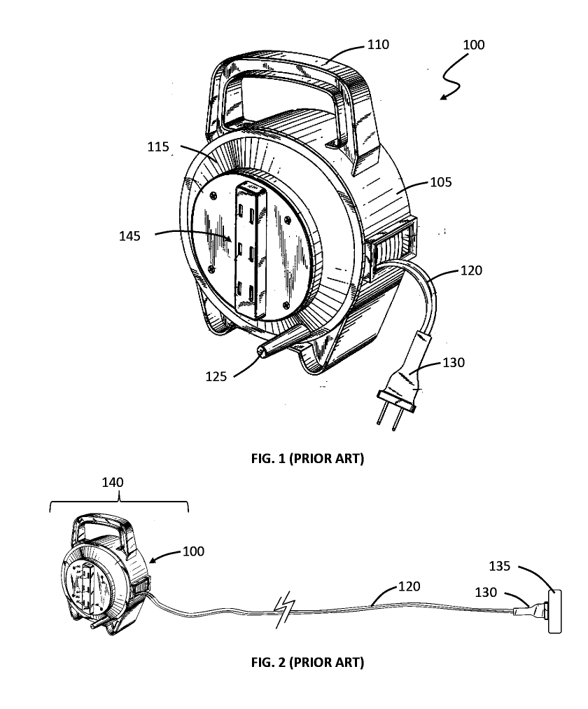

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

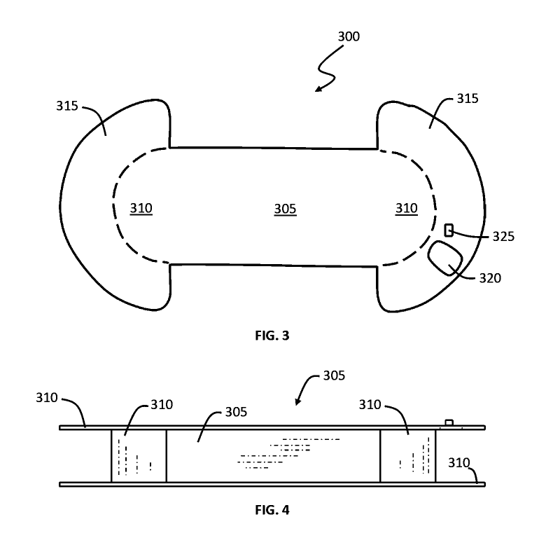

FIG. 3 illustrates a front view of an electrical cord storage device 300, according to an embodiment of the present invention. FIG. 4 illustrates a side view of the electrical cord storage device 300.

The electrical cord storage device 300 includes an elongate body 305 having curved ends 310, for receiving an extension cord (not shown). In particular, the extension cord is manually wrapped around the elongate body, as discussed in further detail below.

The electrical cord storage device 300 includes retaining portions 315 adjacent to the curved ends 310 to prevent the extension cord from sliding off the elongate body 305 when rolled up. The retaining portions 315 form a barrier such that the extension cord must be unrolled from the electrical cord storage device 300 rather than sliding off laterally.

One of the retaining portions 315 defines an aperture 320, which enables a plug end of the extension cord to extend through the retaining portion 315. The electrical cord storage device 300 includes a retaining clip 325 adjacent to the aperture 320 for retaining the plug end of the extension cord to the electrical cord storage device 300.

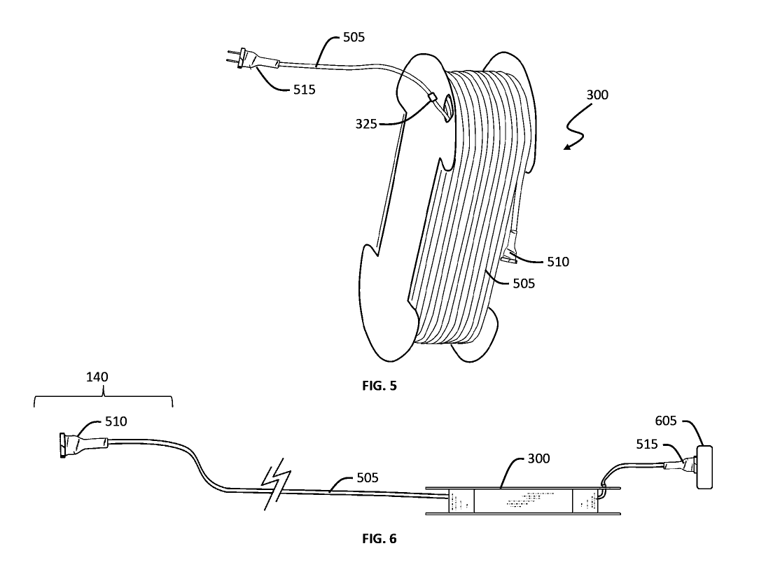

Initially, the plug end of the extension cord is pushed through the aperture 320 and fastened to the retaining clip 325. The remaining part of the extension cord is wound around the elongate body 305. The extension cord is then ready to be used and transported. FIG. 5 illustrates an extension cord 505 on the electrical cord storage device 300.

In use, the extension cord 505 is transported to a work area on the electrical cord storage device 300, as illustrated above. The user then generally unrolls the extension cord 505 from the electrical cord storage device 300 as the user walks towards a power point, such that a socket end 510 of the cord 505 remains at the worksite. At the power point, the user may unroll any remaining extension cord 505 from the electrical cord storage device 300 and plug a plug end 515 of the cord 505 into a socket. FIG. 6 illustrates the extension cord 505 unwound from the electrical cord storage device 300, plugged into an electrical socket 605 and leading to a work area 610. The user may then walk back to the work area 140 and plug an electrical appliance into the socket 510.

After work has completed, the user walks back to the power point 605, unplugs the plug 515, and rolls the extension cord 505 back up onto the electrical cord storage device 300.

By attaching the plug end 515 of the extension cord 505 to the electrical cord storage device 300, the user is encouraged to unplug the extension cord 505 from the power point 605 prior to rolling up the cord 505. As such, the extension cord 505 is wound up while being unplugged, which reduces the risk of electrocution, particularly if the extension cord 505 is damaged.

When the plug end 515 is plugged into the power point 605, manoeuvrability of the electrical cord storage device 300 is hampered, making it difficult to wind the cord back onto the electrical cord storage device 300. As such, while it may be possible to do so, the user has no motivation to attempt to roll up the extension cord 505 while plugged in, and doing so will be time consuming and difficult.

According to certain embodiments, the retaining clip 325 is used to attach the cord such that the plug end 515 is able to extend approximately 0.5 m to 1 m from the electrical cord storage device 300.

FIG. 7 illustrates a front view of an electrical cord storage device 700, according to an embodiment of the present invention. The electrical cord storage device 700 is similar to the electrical cord storage device 300 of FIG. 3, however includes a hook 705, for hanging the electrical cord storage device 700 from, for example, a power supply cabinet.

In use, the electrical cord storage device 700 is used in the same way as the electrical cord storage device 700, but is hung on a cabinet or the like while being plugged in.

The skilled addressee will readily appreciate that the electrical cord storage device 700 may in other embodiments include a ring, enabling the electrical cord storage device 700 to be hung on a hook of the cabinet.

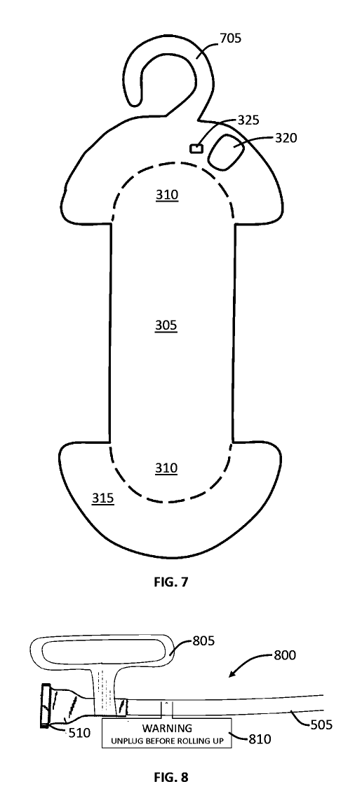

FIG. 8 illustrates an end of an extension cord 800, according to an embodiment of the present invention. The extension cord 800 is similar to the cord 505 of FIG. 5, and can be used together with the electrical cord storage device 300.

The extension cord 800 include a handle 805 adjacent to a socket end of the cord 800, which enables the user to pick up the end of the cord 800 without touching the cord. The handle is made of non-conductive material, such as rubber, to prevent electrocution when in contact with the cord 800, particularly if the cord 800 is damaged.

The extension cord 800 further includes a warning label 810, adjacent to the socket end of the cord 800, which instructs a user to unplug the cord 800 prior to rolling it up. The label 810 may be beneficial if a user is new to the electrical cord storage device 300, to remind the user to wind the cord up from the other end.

The skilled addressee will readily appreciate that various alternative embodiments of the electrical cord storage device 300 are possible, without departing from the present invention. As illustrative examples, electrical cord storage devices may comprise rollers, bags, or any other suitable storage device including means to encourage the user to unplug the cord prior to rolling the cord up for storage.

In the case of a roller, the plug end of the cord 505 may be permanently or semi-permanently attached to the roller such that it is difficult (or impossible) to roll the roller while the plug end is plugged in. In particular, rotation of the roller may cause the plug end of the cord 505 to also rotate, which will cause tangling of the cord 505 if still plugged in. Alternatively, the roller may include an electrically actuated lock, a brake or the like, to prevent the roller from being rolled while plugged in.

According to another aspect, the invention resides in an extension cord, including a switch to selectively couple a plug end of the cord to a cord portion of the cord. In particular, the switch is configured to detect if an appliance is coupled to a socket end of the cord, and selectively switch power from the plug end based thereon.

The switch may be configured to detect a load or resistance at the socket end of the extension cord, and selectively switch power from the plug end to the extension cord only when load or resistance is detected. As such, even if the user would handle the cord while plugged in, now power would be supplied to the cord if no load or resistance is present, making the cord safe to handle in case of damage.

Alternatively, the switch may be configured to detect that a plug has been plugged into the socket end of the cord, and selectively switch power from the plug end to the extension cord only when a plug has been detected at the socket end of the cord. As such, the user simply needs to unplug his or her electrical equipment from the extension cord to de-energise the entire cord.

According to certain embodiments, the socket end of the extension cord may comprise several sockets, to enable several electrical devices to be connected in parallel.

According to some embodiments, the electrical cord is moulded to the storage device. Alternatively, the storage device may be provided to be used together with an existing extension cord.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A portable extension cord safety system including:
an electrical extension cord including a plug end; and
a holder for receiving and holding the electrical extension cord such that the plug end can extend from the holder to provide an extension to a power supply; wherein
the extension cord safety system is configured to encourage a user to unplug the extension cord from the power supply prior to storing the electrical extension cord on the holder.

2. An electrical cord storage device including:
a holder for receiving and storing the electrical extension cord having a plug end, such that the plug end can extend from the holder to provide an extension to a power supply; wherein the storage is configured to encourage a user to unplug the extension cord from the power supply prior to storing the electrical extension cord on the holder.

3. An electrical extension cord including a plug end and a socket end and an elongate cord portion extending between the plug end and the socket end; and a switch at the plug end, configured to selectively decouple couple the plug end from the cord portion of the cord when not in use.
